(19) United States
(12) Patent Application Publication
(10) Pub. No.: US 2024/0114119 A1
(43) Pub. Date: Apr. 4, 2024

(54) IMAGE PROCESSING DEVICE, IMAGE PROCESSING METHOD, AND PROGRAM

(71) Applicant: SONY GROUP CORPORATION, TOKYO (JP)

(72) Inventor: YOSHIAKI SATO, TOKYO (JP)

(21) Appl. No.: 18/547,732

(22) PCT Filed: Jan. 13, 2022
(86) PCT No.: PCT/JP2022/000833

§ 371 Date: Aug. 24, 2023

(30) Foreign Application Priority Data
Mar. 5, 2021 (JP) 2021-035451

(51) Int. Cl. H04N 13/204; G01S 17/86; G06V 10/24; G06V 10/74; H04N 13/271

(52) U.S. Cl. CPC H04N 13/204; G01S 17/86; G06V 10/24; G06V 10/761; H04N 13/271

(57) ABSTRACT

The present technology relates to an image processing device, an image processing method, and a program capable of easily generating a highly accurate depth image.

An image processing device of the present technology includes: a generation unit that generates a reference image in which information indicating ambiguity of a pixel value of each pixel of a depth image acquired from a sensor that measures a distance is set as a pixel value of each pixel; and an integration unit that integrates a plurality of the depth images on the basis of the reference image corresponding to each of the plurality of depth images. The image processing device of the present technology, further includes an alignment unit that performs alignment that is processing of matching a viewpoint of the depth image and a viewpoint of the reference image with a reference viewpoint, and the integration unit integrates the plurality of depth images obtained by the alignment. The present technology can be applied to, for example, a distance measuring system that generates a depth image used for recognizing an object.

### TECHNICAL FIELD

The present technology relates to an image processing device, an image processing method, and a program, and especially relates to an image processing device, an image processing method, and a program capable of easily generating a highly accurate depth image.

### BACKGROUND ART

As a depth camera that performs distance measurement, there are various types of cameras such as a stereo camera and a ToF camera. Since a good distance measurement target differs depending on the type of each camera, distance measurement can be performed in various environments by fusing distance information measured by a plurality of cameras.

For example, Patent Document 1 describes a technology of fusing measurement results of a plurality of sensors on the basis of likelihood recorded in each cell obtained by dividing a three-dimensional space.

### CITATION LIST

### Patent Documents

Patent Document 1: WO 2017/057056 A
Patent Document 2: Japanese Patent Application Laid-Open No. 2007-310741

### SUMMARY OF THE INVENTION

### Problems to be Solved by the Invention

In the technology described in Patent Document 1, since the likelihood of cells obtained by finely dividing the space is handled in order to generate a high-resolution depth image, a large amount of memory is required.

The present technology has been made in view of such a situation, and enables easy generation of a highly accurate depth image.

### Solutions to Problems

An image processing device according to one aspect of the present technology includes: a generation unit that generates a reference image in which information indicating ambiguity of a pixel value of each pixel of a depth image acquired from a sensor that measures a distance is set as a pixel value of each pixel; and an integration unit that integrates a plurality of the depth images on the basis of the reference image corresponding to each of the plurality of the depth images.

In one aspect of the present technology, a reference image is generated in which information indicating ambiguity of a pixel value of each pixel of a depth image acquired from a sensor that measures a distance is set as a pixel value of each pixel, and a plurality of the depth images is integrated on the basis of the reference image corresponding to each of the plurality of the depth images.

### BRIEF DESCRIPTION OF DRAWINGS

FIG. 1 is a block diagram illustrating a configuration example of a distance measuring system according to one embodiment of the present technology.

FIG. 2 is a diagram illustrating examples of fitting methods.

FIG. 3 is a diagram for explaining an outline of an algorithm of aligning depth images.

FIG. 4 is a diagram illustrating features of a ToF camera.

FIG. 5 is a diagram illustrating features of a stereo camera.

FIG. 6 is a diagram illustrating an example of a use scene of the distance measuring system of the present technology.

FIG. 7 is a flowchart for explaining processing of the distance measuring system.

FIG. 8 is a flowchart for explaining standard deviation estimation processing of the ToF camera.

FIG. 9 is a flowchart for explaining standard deviation estimation processing of the stereo camera.

FIG. 10 is a flowchart for explaining alignment processing.

FIG. 11 is a flowchart for explaining integration processing.

FIG. 12 is a block diagram illustrating another configuration example of the distance measuring system.

FIG. 13 is a block diagram illustrating a configuration example of hardware of a computer.

### MODE FOR CARRYING OUT THE INVENTION

<<Outline of Present Technology>>

The present technology generates, for a plurality of depth images, a standard deviation image in which information indicating ambiguity of a pixel value of each pixel of the depth image is recorded as a pixel value, and integrates the plurality of depth images into one depth image on the basis of the standard deviation images, thereby enabling generation of a highly accurate depth image while maintaining resolution of the image.

Hereinafter, a mode for carrying out the present technology will be described. The description will be made in the following order.
1. Distance Measuring System
2. Operation of Distance Measuring System
3. Modifications

### 1. DISTANCE MEASURING SYSTEM

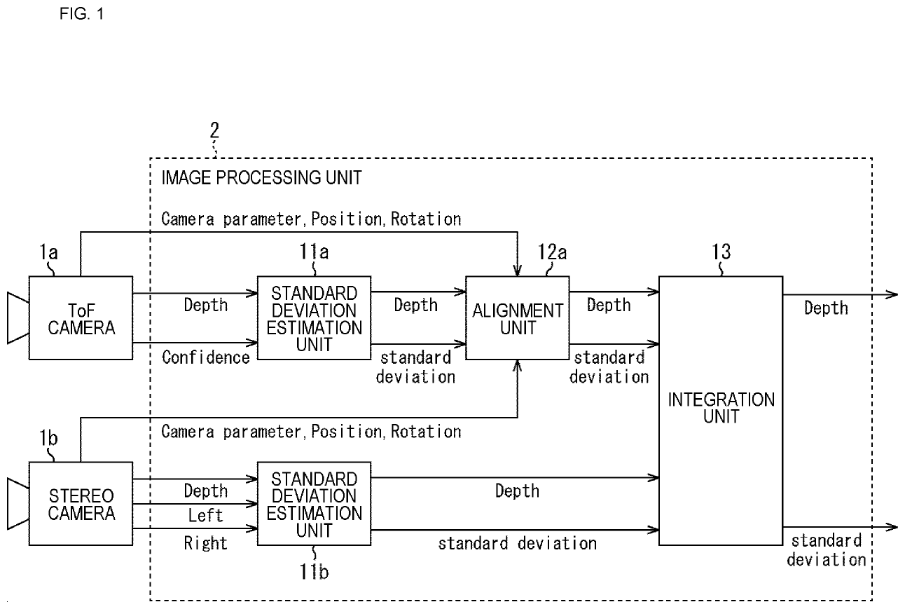

FIG. 1 is a block diagram illustrating a configuration example of a distance measuring system according to one embodiment of the present technology.

The distance measuring system of the present technology is a system that integrates depth images generated by a plurality of depth cameras having different distance measuring methods.

The distance measuring system in FIG. 1 includes a time of flight (ToF) camera 1a, a stereo camera 1b, and an image processing unit 2. The respective configurations may be provided in different casings, or may be provided in the same casing.

The ToF camera 1a is a depth camera that performs distance measurement by emitting infrared light and receiving reflected light reflected by an object by an imager. The ToF camera 1a measures a distance to the object on the basis of a time from light emission timing to light reception timing, and generates a ToF depth image which is a depth image in which depth information is recorded as a pixel value. The depth information is information indicating the distance to the object.

The ToF depth image and a confidence image generated by the ToF camera 1a are supplied to the image processing unit 2. The confidence image is an image representing intensity of the reflected light received by the imager.

The stereo camera 1b is a depth camera that measures a distance to the object on the basis of left and right images. The stereo camera 1b generates a stereo depth image which is a depth image in which depth information is recorded as a pixel value. The left and right images are, for example, two monochrome images having parallax obtained by imaging by two cameras constituting the stereo camera 1b.

The stereo depth image and the left and right images generated by the stereo camera 1b are supplied to the image processing unit 2.

The image processing unit 2 includes a standard deviation estimation unit 11a, a standard deviation estimation unit 11b, an alignment unit 12a, and an integration unit 13.

The standard deviation estimation unit 11a estimates a standard deviation of the depth information recorded in each pixel of the ToF depth image on the basis of the confidence image supplied from the ToF camera 1a, and generates a standard deviation image. The standard deviation image is an image in which the standard deviation of the depth information is recorded as the pixel value of the pixel corresponding to the pixel of the depth image, and is an image having the same resolution as the resolution of the depth image. Furthermore, the standard deviation image is a reference image referred to for integration of a plurality of depth images. The standard deviation estimation unit 11a functions as a generation unit that generates a reference image.

The standard deviation image generated by the standard deviation estimation unit 11a is supplied to the alignment unit 12a together with the ToF depth image.

The standard deviation estimation unit 11b estimates a standard deviation of the depth information recorded in each pixel of the stereo depth image on the basis of strength of matching between the left and right images supplied from the stereo camera 1b, and generates a standard deviation image.

The standard deviation image generated by the standard deviation estimation unit 11b is supplied to the integration unit 13 together with the stereo depth image.

The alignment unit 12a performs alignment that is processing of matching viewpoints of the ToF depth image and the standard deviation image with a viewpoint of the stereo depth image as a reference viewpoint. The alignment is performed on the basis of information on camera parameters, positions, and rotations of the ToF camera 1a and the stereo camera 1b. The information on the camera parameters and the like of the ToF camera 1a and the stereo camera 1b is supplied to the alignment unit 12a.

The aligned ToF depth image and standard deviation image obtained by performing alignment by the alignment unit 12a are supplied to the integration unit 13.

The integration unit 13 integrates the ToF depth image supplied from the alignment unit 12a and the stereo depth image supplied from the standard deviation estimation unit 11b on the basis of two standard deviation images corresponding to the respective depth images. Furthermore, the integration unit 13 integrates two standard deviation images corresponding to the ToF depth image and the stereo depth image.

The depth image and the standard deviation image integrated by the integration unit 13 are output to a subsequent processing unit or another external device. On the basis of the depth information represented by the depth image output from the image processing unit 2, various processing such as recognition of an object is performed.

<Details of Each Configuration of Image Processing Unit>

(1.1) Standard Deviation for Every Pixel

In the standard deviation estimation unit 11a and the standard deviation estimation unit 11b, a distance error is estimated as a standard deviation for every pixel of the depth image.

In the integration unit 13, weight having a large value is set to a pixel having a small error, and small weight is set to a pixel having a large error. A result of a weighted average of the depth information based on the weight is recorded as a pixel value of each pixel of the depth image. By integrating the pixels of the depth image on the basis of the weight according to the errors, accuracy of the distance recorded in each pixel can be improved.

(1.1.1) Standard Deviation for Every Pixel of ToF Camera (about Standard Deviation Estimation Unit 11a)

The ToF camera 1a includes, for example, an indirect time of flight (iToF) camera that emits light with modulated intensity toward an object and measures a distance on the basis of a change in phase of reflected light.

The standard deviation estimation unit 11a calculates a standard deviation of a distance for every pixel of the ToF depth image on the basis of a model representing degradation due to shot noise in the ToF camera 1a.

The standard deviation of the distance due to the shot noise has a feature that the standard deviation asymptotically approaches 0 when a light amount is large. Furthermore, the standard deviation of the distance due to the shot noise has a feature that it is uniformly distributed when the light amount is small, and an expected value and variance of the depth diverge. An approximate standard deviation Gr e d of this offset normal distribution is proportional to a reciprocal of amplitude A and is expressed by the following Formula (1).

$$\begin{matrix}[ Mathematical Formula 1 ] & \\ {σ}_{red} = \frac{{σ}_{0}}{A} & ( 1 )\end{matrix}$$

In Formula (1), Go is a constant. The amplitude A represents intensity of light recorded in each pixel of the confidence image. The standard deviation estimation unit 11a calculates the standard deviation G red for every pixel of the ToF depth image using Formula (1), and records it as a pixel value of the standard deviation image.

(1.1.2) Standard Deviation for Every Pixel of Stereo Camera (About Standard Deviation Estimation Unit 11b) The standard deviation estimation unit 11b estimates a standard deviation of a distance for every pixel of the stereo depth image on the basis of a distance measurement principle of the stereo camera 1b.

The stereo camera 1b obtains parallax by matching pixels of the left and right images, and measures a distance to an object by a principle of triangulation. The parallax obtained by the stereo camera 1b includes an error. An error occurs in a case where texture of the object is small, in a case where there is a repetitive pattern, in a case where there are many noise components, or the like. Therefore, for example, the parallax error is small in an area with a large texture.

Furthermore, due to the principle of triangulation, an error included in a distance measured by the stereo camera 1b is proportional to the square of an actual distance. Therefore, for example, the error included in the distance to the object measured by the stereo camera 1b increases as the object moves away from the stereo camera 1b.

In the stereo camera 1b, parallax in subpixel units smaller than pixel units is calculated. The parallax calculation is performed using, for example, an equiangular straight line fitting method or a parabolic fitting method.

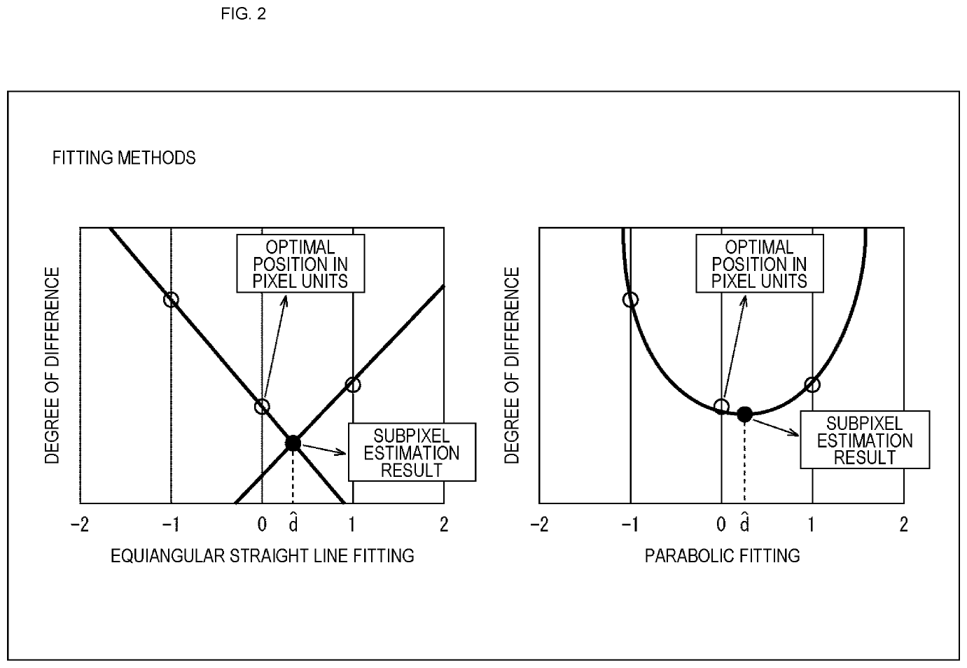

FIG. 2 is a diagram illustrating examples of fitting methods.

Both the equiangular straight line fitting and parabolic fitting methods are methods for estimating parallax on the basis of a position of a pixel on a depth image and a degree of correlation of matching. In FIG. 2, the horizontal axis represents a position on the depth image, and the vertical axis represents a degree of difference. The position on the depth image represents a position in pixel units based on an optimum pixel of the matching.

As illustrated on a left side of FIG. 2, in the equiangular straight line fitting, a subpixel estimate d is obtained on the basis of two straight lines passing through a degree of difference in the optimal pixel and degrees of difference in pixels before and after the optimal pixel. Furthermore, as illustrated on a right side of FIG. 2, in the parabolic fitting, a subpixel estimate d is obtained on the basis of a curve passing through a degree of difference in the optimal pixel and degrees of difference in pixels before and after the optimal pixel. The subpixel estimate d represents parallax.

The standard deviation estimation unit 11b estimates a standard deviation of a distance on the basis of ambiguity of stereo matching in a case where the parabolic fitting is used, for example. The standard deviation of the distance may be estimated on the basis of ambiguity of stereo matching in a case where the equiangular straight line fitting is used.

Assuming that a is a correlation coefficient (degree of difference) for a pixel in coordinates −1, that b is a correlation coefficient for a pixel in coordinates 0 (optimal pixel), and that c is a correlation coefficient for a pixel in coordinates 1, the subpixel estimate d in the parabolic fitting is expressed by the following Formula (2).

$$\begin{matrix}[ Mathematical Formula 2 ] & \\ d = \frac{a - c}{2 a - 4 b + 2 c} & ( 2 )\end{matrix}$$

Assuming that errors of the correlation coefficients for the pixels in coordinates −1, 0, and 1 are Δa, Δb, and Δc, respectively, an error Δdₘ of the subpixel estimate d due to the parabolic fitting is obtained on the basis of Formula (2) by error theory. The error Δdₘ is expressed by the following Formula (3).

$$\begin{matrix}[ Mathematical Formula 3 ] & \\ Δ {d}_{m} = \vert \frac{\partial d}{\partial a} \vert Δ a + \vert \frac{\partial d}{\partial b} \vert Δ b + \vert \frac{\partial d}{\partial c} \vert Δ c & ( 3 )\end{matrix}$$

In Formula (3), |∂d/∂a|, |∂d/∂b|, and |∂d/∂c| are expressed as the following Formulas (4), (5), and (6), respectively.

$$\begin{matrix}[ Mathematical Formula 4 ] & \\ \begin{matrix}\frac{\partial d}{\partial a} = \frac{\partial }{\partial a} ( \frac{a - c}{2 a - 4 b + 2 c} ) \\ = \frac{\frac{\partial }{\partial a} ( a - c ) ( 2 a - 4 b + 2 c ) - ( a - c ) \frac{\partial }{\partial a} ( 2 a - 4 b + 2 c )}{{( 2 a - 4 b + 2 c )}^{2}} \\ = \frac{( 2 a - 4 b + 2 c ) - ( a - c ) 2}{{( 2 a - 4 b + 2 c )}^{2}} \\ = \frac{4 ( c - b )}{{( 2 a - 4 b + 2 c )}^{2}}\end{matrix} & ( 4 )\end{matrix}$$

$$\begin{matrix}[ Mathematical Formula 5 ] & \\ \begin{matrix}\frac{\partial d}{\partial a} = \frac{\partial }{\partial b} ( \frac{a - c}{2 a - 4 b + 2 c} ) \\ = \frac{\frac{\partial }{\partial b} ( a - c ) ( 2 a - 4 b + 2 c ) - ( a - c ) \frac{\partial }{\partial b} ( 2 a - 4 b + 2 c )}{{( 2 a - 4 b + 2 c )}^{2}} \\ = \frac{0 - ( a - c ) ( - 4 )}{{( 2 a - 4 b + 2 c )}^{2}} \\ = \frac{4 ( c - a )}{{( 2 a - 4 b + 2 c )}^{2}}\end{matrix} & ( 5 )\end{matrix}$$

$$\begin{matrix}[ Mathematical Formula 6 ] & \\ \begin{matrix}\frac{\partial d}{\partial c} = \frac{\partial }{\partial c} ( \frac{a - c}{2 a - 4 b + 2 c} ) \\ = \frac{\frac{\partial }{\partial c} ( a - c ) ( 2 a - 4 b + 2 c ) - ( a - c ) \frac{\partial }{\partial c} ( 2 a - 4 b + 2 c )}{{( 2 a - 4 b + 2 c )}^{2}} \\ = \frac{( - 1 ) ( 2 a - 4 b + 2 c ) - ( a - c ) 2}{{( 2 a - 4 b + 2 c )}^{2}} \\ = \frac{4 ( b - a )}{{( 2 a - 4 b + 2 c )}^{2}}\end{matrix} & ( 6 )\end{matrix}$$

When Formula (3) is deformed using Formulas (4), (5), and (6), the following Formula (7) is obtained.

$$\begin{matrix}[ Mathematical Formula 7 ] & \\ \begin{matrix}Δ {d}_{m} = \vert \frac{\partial d}{\partial a} \vert Δ a + \vert \frac{\partial d}{\partial b} \vert Δ b + \vert \frac{\partial d}{\partial c} \vert Δ c \\ = \vert \frac{4 ( c - b )}{{( 2 a - 4 b + 2 c )}^{2}} \vert Δ c + \vert \frac{4 ( c - a )}{{( 2 a - 4 b + 2 c )}^{2}} \vert Δ c + \vert \frac{4 ( b - a )}{{( 2 a - 4 b + 2 c )}^{2}} \vert Δ c \\ = \frac{4 Δ c}{{( 2 a - 4 b + 2 c )}^{2}} ( \vert c - b \vert + \vert c - a \vert + \vert b - a \vert )\end{matrix} & ( 7 )\end{matrix}$$

In Formula (7), the formula is organized as Δa=Δb=Δc on the assumption that the error of the correlation coefficient does not depend on the position of the pixel.

Here, assuming that z is a distance, f is a focal length, and B is a stereo camera baseline length, a relationship between the parallax d and the distance z is expressed by the following Formula (8). When Formula (7) is deformed using Formula (8), the following Formula (9) is obtained.

$$\begin{matrix}[ Mathematical Formula 8 ] & \\ z = \frac{f B}{d} & ( 8 )\end{matrix}$$

$$\begin{matrix}[ Mathematical Formula 9 ] & \\ \begin{matrix}Δ z = \vert \frac{\partial z}{\partial d} \vert Δ {d}_{m} \\ = \frac{fB}{{d}^{2}} Δ {d}_{m} \\ = \vert \frac{\partial z}{\partial d} ( \frac{fB}{d} ) \vert Δ {d}_{m} \\ = \frac{fB}{{d}^{2}} ( \frac{4}{{( 2 a - 4 b + 2 c )}^{2}} ( \vert c - b \vert + \vert c - a \vert + \vert b - a \vert ) Δ c )\end{matrix} & ( 9 )\end{matrix}$$

Formula (9) indicates that a distance error Δz increases as a difference between correlation coefficients of matching before and after the optimal pixel is small. Specifically, in an area having a small texture such as a light-colored wall surface, a value of the error Δz increases because uncertainty is large. Matching becomes easy on a surface having a pattern, and thus the value of the error Δz becomes small.

The standard deviation estimation unit 11a calculates the error Δz using Formula (9) for every pixel of the stereo depth image, and records it as a pixel value of the standard deviation image.

(1.2) Image Alignment (about Alignment Unit 12a)

The alignment unit 12a performs alignment of a total of six degrees of freedom of three degrees of freedom corresponding to rotation of a three-dimensional space and three degrees of freedom corresponding to translation on a depth image as processing before integration processing by the integration unit 13. The alignment is an operation of transforming a viewpoint of a depth image of an alignment source into a viewpoint of a depth image of an alignment destination.

Parameters used for alignment in six degrees of freedom between two depth cameras are estimated by calibration using a test board or the like.

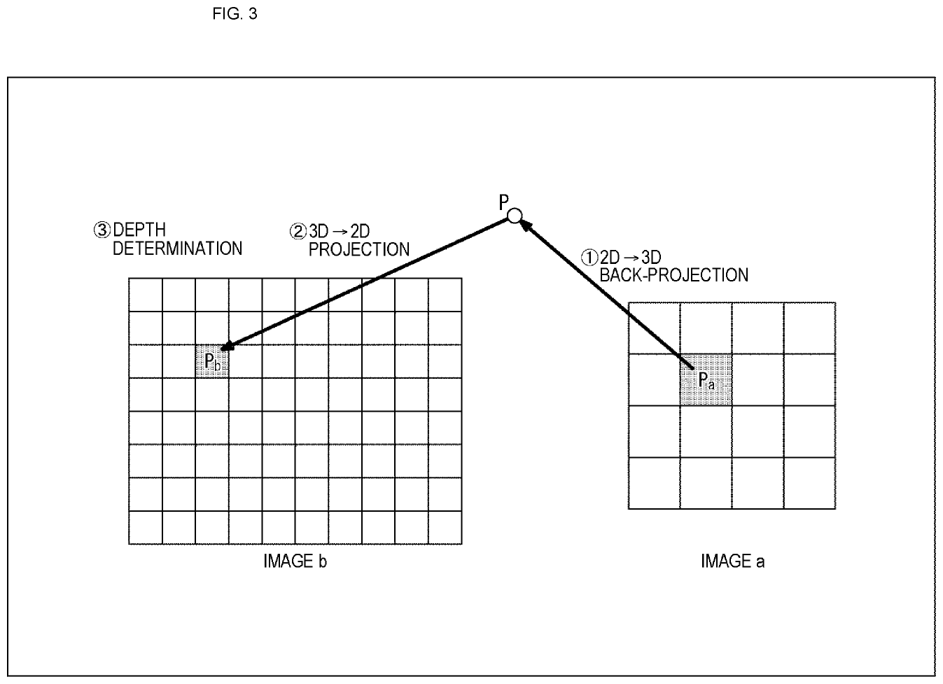

FIG. 3 is a diagram for explaining an outline of an algorithm of aligning depth images.

FIG. 3 illustrates alignment in which a pixel value of a pixel in coordinates pₐ=(uₐ, vₐ) on an image a is set as a pixel value of a pixel in coordinates p_{b}=(u_{b}, v_{b}) on an image b. For example, the image a corresponds to an image of a viewpoint of the ToF camera 1a as the alignment source, and the image b corresponds to an image of a viewpoint of the stereo camera 1b as the alignment destination.

Unlike a two-dimensional RGB image, the depth image has three-dimensional information. Therefore, in the alignment of the depth images, the coordinates pₐ on the image of the alignment source is transformed to the coordinates p_{b} on the image after the alignment via a point P on the three-dimensional space.

First, assuming that the ToF camera 1a is a camera a, the coordinates pₐ on the image a are back-projected to coordinates Pₐ=(Xₐ Yₐ Zₐ)^{T} of the point P on a coordinate system centered on the camera a. A relationship between the coordinates pₐ and Pₐ is expressed by the following Formula (10) using a camera parameter Kₐ of the camera a. The camera parameter Kₐ is expressed by the following Formula (11).

$$\begin{matrix}[ Mathematical Formula 10 ] & \\ {s}_{a} ( \begin{matrix}{u}_{a} \\ {v}_{a} \\ 1\end{matrix} ) = {K}_{a} ( \begin{matrix}{X}_{a} \\ {Y}_{a} \\ {Z}_{a}\end{matrix} ) & ( 10 )\end{matrix}$$

$$\begin{matrix}[ Mathematical Formula 11 ] & \\ {K}_{a} = ( \begin{matrix}{f}_{ua} & 0 & {c}_{ua} \\ 0 & {f}_{va} & {c}_{va} \\ 0 & 0 & 1\end{matrix} ) & ( 11 )\end{matrix}$$

In Formula (10), s a is a proportional constant. Furthermore, in Formula (11), fᵤₐ and fᵥₐ are focal lengths, and cᵤₐ and cᵥₐ are image centers.

On the other hand, assuming that the stereo camera 1b is a camera b, coordinates P_{b}=(X_{b} Y_{b} Z_{b})^{T} of the point P on a coordinate system centered on the camera b is projected to the coordinates p_{b} on the image b. A relationship between the coordinates p_{b} and P_{b} is expressed by the following Formula (12) using a camera parameter K_{b} of the camera b.

$$\begin{matrix}[ Mathematical Formula 12 ] & \\ {s}_{b} ( \begin{matrix}{u}_{b} \\ {v}_{b} \\ 1\end{matrix} ) = {K}_{a} ( \begin{matrix}{X}_{b} \\ {Y}_{b} \\ {Z}_{b}\end{matrix} ) & ( 12 )\end{matrix}$$

In Formula (12), s_{b} is a proportional constant. Here, a relationship between the coordinates Pₐ and the coordinate P_{b} expressed by the different coordinate systems is expressed by the following Formula (13).

$$\begin{matrix}[ Mathematical Formula 13 ] & \\ ( \begin{matrix}{X}_{b} \\ {Y}_{b} \\ {Z}_{b}\end{matrix} ) = ( R \vert t ) ( \begin{matrix}{X}_{a} \\ {Y}_{a} \\ {Z}_{a} \\ 1\end{matrix} ) & ( 13 )\end{matrix}$$

In Formula (13), (R|t) is a matrix of three rows and four columns obtained by combining a rotation matrix R representing rotation from the coordinate system of the camera a to the coordinate system of the camera b and a translation vector t from an origin of the coordinate system of the camera a to an origin of the coordinate system of the camera b. (R|t) is obtained by camera calibration.

The following Formulas (14) and (15) are obtained using Formulas (10), (12), and (13).

$$\begin{matrix}[ Mathematical Formula 14 ] & \\ {P}_{a} = {K}_{a}^{- 1} {s}_{a} ( \begin{matrix}{U}_{a} \\ {V}_{a} \\ 1\end{matrix} ) & ( 14 )\end{matrix}$$

$$\begin{matrix}[ Mathematical Formula 15 ] & \\ {s}_{b} ( \begin{matrix}{u}_{b} \\ {v}_{b} \\ 1\end{matrix} ) = {K}_{b} ( R \vert t ) ( \begin{matrix}{P}_{a} \\ 1\end{matrix} ) & ( 15 )\end{matrix}$$

The alignment unit 12a transforms the coordinates on the image a before alignment into the coordinates on the image b after alignment using Formula (15), and performs alignment.

Furthermore, as processing before the integration processing by the integration unit 13, the alignment unit 12a unifies sizes of the images based on an internal parameter of the camera in addition to the alignment. For example, by performing upsampling or the like before performing the alignment, the sizes of the images are unified. A value calibrated in advance is used as the internal parameter of the camera.

(1.3) Integration (about Integration Unit 13)

The integration unit 13 performs weighting on a pixel value of each pixel of a depth image on the basis of a standard deviation, and integrates the pixels of the plurality of depth images. Ambiguity of a distance zo as a pixel value is expressed by the following Formula (16) as a distribution using a variance σ².

$$\begin{matrix}[ Mathematical Formula 16 ] & \\ N ( {z}_{0} , {σ}^{2} ) = \frac{1}{\sqrt{2 π {σ}^{2}}} exp ( - \frac{{( z - {z}_{0} )}^{2}}{2 {σ}^{2}} ) & ( 16 )\end{matrix}$$

Here, σₐ² represents a variance of a pixel a of the ToF depth image, and z a represents a distance recorded as a pixel value of the pixel a. Furthermore, σ_{b}² represents a variance of a pixel b of the stereo depth image, and z_{b} represents a distance recorded as a pixel value of the pixel b.

In this case, a distance distribution obtained by integrating two depths, the distance z a represented by a distribution of N(zₐ, σₐ²) and the distance z_{b} represented by a distribution of N(z_{b}, σ_{b}²), is expressed by the following Formula (17).

$$\begin{matrix}[ Mathematical Formula 17 ] & \\ N ( \frac{{σ}_{a}^{2} {z}_{b} + {σ}_{b}^{2} {z}_{a}}{{σ}_{a}^{2} + {σ}_{b}^{2}} , \frac{{σ}_{a}^{2} {σ}_{b}^{2}}{{σ}_{a}^{2} + {σ}_{b}^{2}} ) & ( 17 )\end{matrix}$$

Formula (17) represents a product of two probability density functions represented by a normal distribution and corresponds to update of a Kalman filter. On the basis of Formula (17), an integrated distance is obtained by the following Formula (18), and the variance G 2 is obtained by the following Formula (19).

$$\begin{matrix}[ Mathematical Formula 18 ] & \\ Z = \frac{{σ}_{a}^{2} {z}_{b} + {σ}_{b}^{2} {z}_{a}}{{σ}_{a}^{2} + {σ}_{b}^{2}} & ( 18 )\end{matrix}$$

$$\begin{matrix}[ Mathematical Formula 19 ] & \\ {σ}^{2} = \frac{{σ}_{a}^{2} {σ}_{b}^{2}}{{σ}_{a}^{2} + {σ}_{b}^{2}} & ( 19 )\end{matrix}$$

The integration unit 13 generates an integrated depth image by recording the integrated distance z as a pixel value. Furthermore, the integration unit 13 generates an integrated standard deviation image by recording the integrated standard deviation σ as a pixel value.

Note that three or more images may be integrated by the integration unit 13. The integration of three or more images is performed by sequentially integrating the images one by one, for example, by integrating two images and then integrating the integrated image and the third image. Regardless of order of the images to be integrated, a final obtained result is constant.

<Effects>

In the distance measuring system of the present technology, depth images generated by a plurality of types of depth cameras are integrated to generate depth images utilizing characteristics of the respective depth cameras.

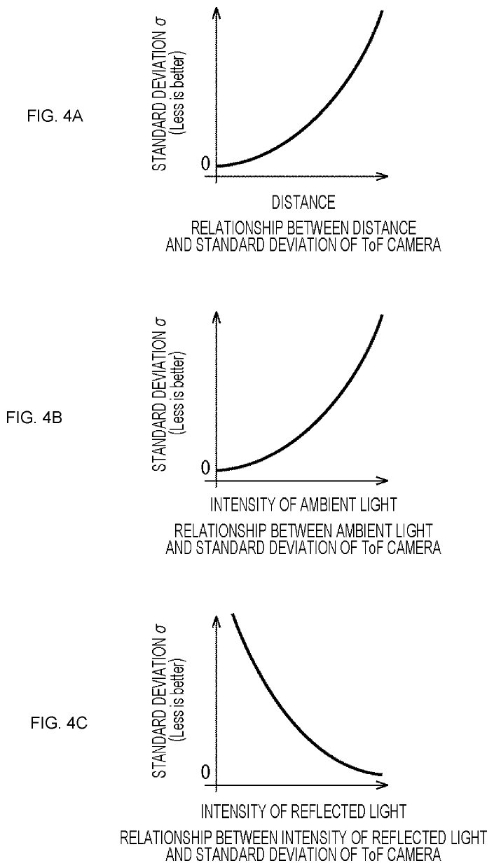

FIG. 4 is a diagram illustrating features of the ToF camera 1a.

A of FIG. 4 is a diagram illustrating a relationship between a distance to an object and a standard deviation. The horizontal axis represents the distance, and the vertical axis represents the standard deviation G.

As illustrated in A of FIG. 4, the standard deviation σ of the distance measured by the ToF camera 1a increases as the distance to the object increases.

B of FIG. 4 is a diagram illustrating a relationship between intensity of ambient light and the standard deviation. The horizontal axis represents the intensity of the ambient light, and the vertical axis represents the standard deviation.

As illustrated in B of FIG. 4, the standard deviation σ of the distance measured by the ToF camera 1a increases as the intensity of the ambient light such as sunlight increases.

C of FIG. 4 is a diagram illustrating a relationship between intensity of reflected light and the standard deviation. The horizontal axis represents the intensity of the reflected light, and the vertical axis represents the standard deviation.

As illustrated in C of FIG. 4, the standard deviation σ of the distance measured by the ToF camera 1a decreases as the intensity of the reflected light emitted from the ToF camera 1a and reflected by the object increases. The intensity of the reflected light increases, for example, as color of the object is closer to white. Therefore, in a case where the color of the object is close to black, the standard deviation of the distance measured by the ToF camera 1a is a large value.

As described above, according to the ToF camera 1a, for example, a distance to a white wall without texture can be measured, and the distance can be measured even in a dark environment. The ToF camera 1a has a feature that a distance can be accurately measured in an artificial environment such as indoors.

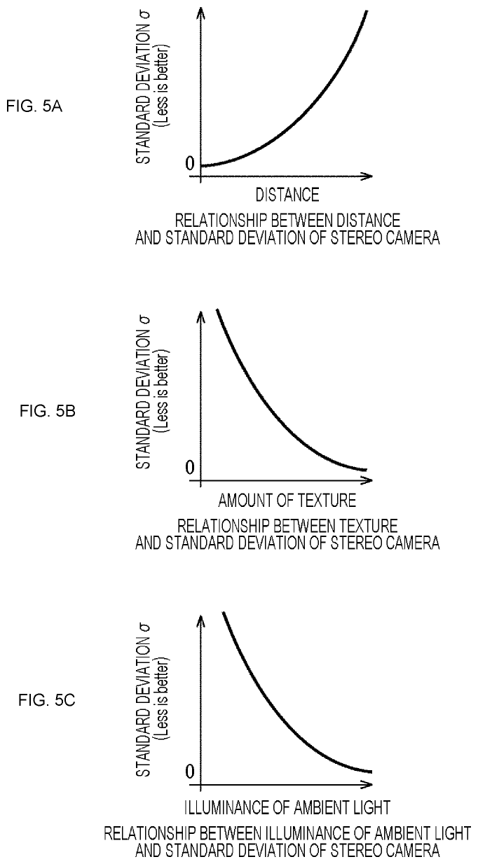

FIG. 5 is a diagram illustrating features of the stereo camera 1b.

A of FIG. 5 is a diagram illustrating a relationship between a distance to an object and a standard deviation. The horizontal axis represents the distance, and the vertical axis represents the standard deviation G.

As illustrated in A of FIG. 5, the standard deviation σ of the distance measured by the stereo camera 1b is proportional to the square of the distance to the object. Note that the stereo camera 1b can accurately measure the distance to a distant object as compared with the ToF camera 1a.

B of FIG. 5 is a diagram illustrating a relationship between an amount of texture of the object and the standard deviation. The horizontal axis represents an amount of texture, and the vertical axis represents the standard deviation 6.

As illustrated in B of FIG. 5, the standard deviation σ of the distance measured by the stereo camera 1b decreases as the texture of the object increases. Therefore, in a case where the distance is measured in an artificial environment such as indoors where the texture of the object is small, the standard deviation of the distance measured by the stereo camera 1b becomes a large value.

C of FIG. 5 is a diagram illustrating a relationship between illuminance of ambient light and the standard deviation. The horizontal axis represents the illuminance of the ambient light, and the vertical axis represents the standard deviation (7.

As illustrated in C of FIG. 5, the standard deviation σ of the distance measured by the stereo camera 1b decreases as the illuminance of the ambient light increases. Therefore, in a case where the distance is measured in an outdoor environment such as under direct sunlight, noise included in the distance measured by the stereo camera 1b is reduced.

As described above, the stereo camera 1b has a feature that the distance to the distant object can be measured. Furthermore, the stereo camera 1b has a feature that the distance can be accurately measured in an environment such as outdoors.

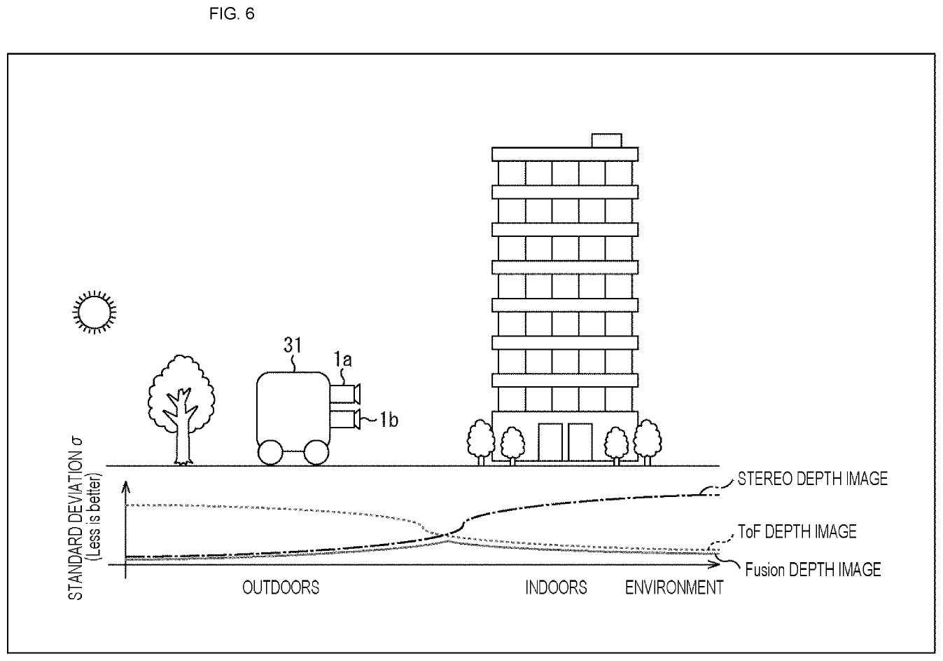

FIG. 6 is a diagram illustrating an example of a use scene of the distance measuring system of the present technology.

As illustrated in FIG. 6, the distance measuring system of the present technology is mounted on, for example, a robot 31 which is a mobile body that moves between indoors and outdoors. The ToF camera 1a and the stereo camera 1b are provided in a casing of the robot 31. The image processing unit 2 is provided inside the casing of the robot 31, for example.

In the image processing unit 2, a ToF depth image and a stereo depth image are integrated on the basis of a standard deviation of a distance. Therefore, it is possible to preferentially integrate the depth images generated by the depth camera having high measurement accuracy of the distance in an environment around the robot 31 between the ToF camera 1a and the stereo camera 1b.

In a case where the robot 31 is located outdoors, as illustrated in the lower part of FIG. 6, since the standard deviation of the stereo image is smaller than the standard deviation of the ToF depth image, the image processing unit 2 preferentially integrates the stereo depth image.

Furthermore, in a case where the robot 31 is located indoors, since the standard deviation of the ToF depth image is smaller than the standard deviation of the stereo depth image, the image processing unit 2 preferentially integrates the ToF depth image.

Furthermore, even in a case where the robot 31 is located indoors, in a pixel in which the standard deviation of the stereo depth image is smaller than the standard deviation of the ToF depth image, the pixel of the stereo depth image is preferentially integrated. Even in a case where the robot 31 is located outdoors, in a pixel in which the standard deviation of the ToF depth image is smaller than the standard deviation of the stereo image, the pixel of the ToF depth image is preferentially integrated.

As described above, by integrating the depth images of the depth cameras having different features on the basis of the standard deviation estimated for every pixel of the depth image, a standard deviation of a depth image after integration (Fusion depth image) is smaller than the standard deviation of the depth image of each of the ToF camera 1a and the stereo camera 1b in both the indoor environment and the outdoor environment, as indicated by a thick line in the lower part of FIG. 6.

Therefore, even in a case where the robot 31 moves from indoors to outdoors, the distance measuring system can continue to measure the distance with high accuracy.

Since the integration is performed for every pixel of the depth image on the basis of the standard deviation estimated for every pixel of the depth image, the distance measuring system can stochastically integrate pixel values of the pixels of the plurality of depth images while maintaining resolution of the images, and generate a highly accurate depth image.

In the depth camera, one piece of distance information is measured per pixel. Even in a case where an erroneous distance is measured by a certain depth camera, since the standard deviation is obtained for every pixel, the erroneous distance and a correct distance can be integrated with different weighting. Since the weight is set for every pixel, it is possible to reduce an influence of a false point of the stereo camera.

### 2. OPERATION OF DISTANCE MEASURING SYSTEM

<Overall Processing>

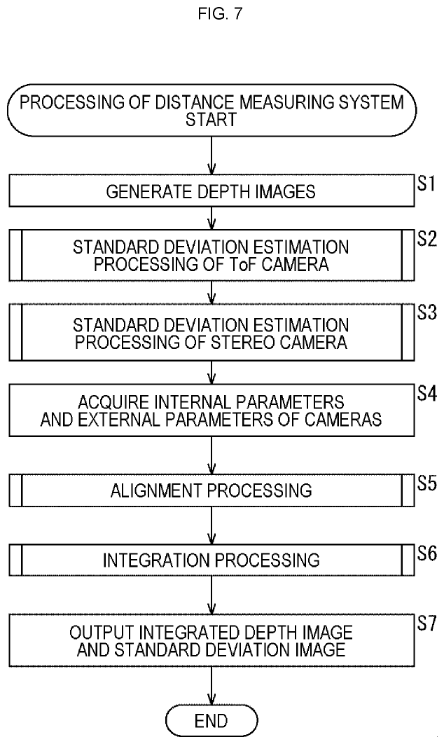

Processing of the distance measuring system having the above configuration will be described with reference to a flowchart of FIG. 7.

In step S1, the ToF camera 1a and the stereo camera 1b generate depth images. Together with the depth images, a confidence image is generated by the ToF camera 1a, and left and right images are generated by the stereo camera 1b.

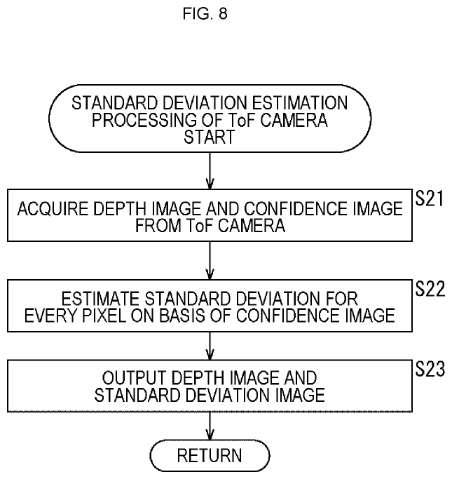

In step S2, the standard deviation estimation unit 11a performs standard deviation estimation processing of the ToF camera. In the standard deviation estimation processing of the ToF camera, a standard deviation of a pixel value is estimated for every pixel of the ToF depth image, and a standard deviation image is generated. Details of the standard deviation estimation processing of the ToF camera will be described later with reference to a flowchart of FIG. 8.

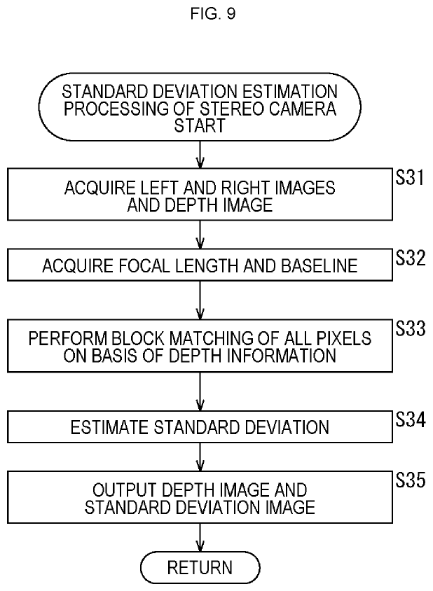

In step S3, the standard deviation estimation unit 11b performs standard deviation estimation processing of the stereo camera. In the standard deviation estimation processing of the stereo camera, a standard deviation of a pixel value is estimated for every pixel of the stereo depth image, and a standard deviation image is generated. Details of the standard deviation estimation processing of the stereo camera will be described later with reference to a flowchart of FIG. 9.

In step S4, the alignment unit 12a acquires an internal parameter and an external parameter of each of the ToF camera 1a and the stereo camera 1b.

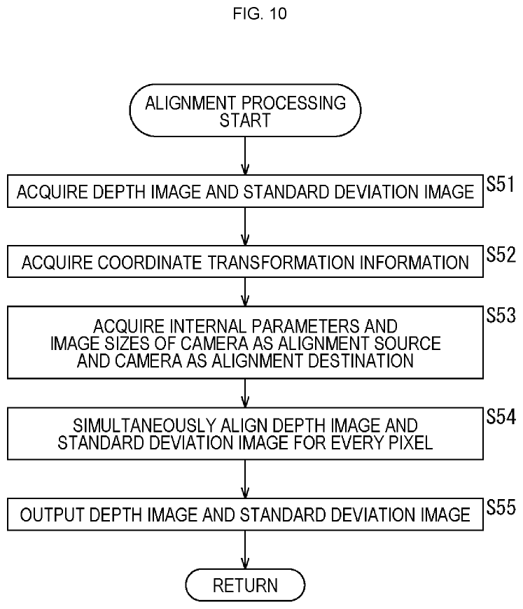

In step S5, the alignment unit 12a performs alignment processing. In the alignment processing, processing of matching viewpoints of the ToF depth image and the standard deviation image with a viewpoint of the stereo camera 1b is performed. Details of the alignment processing will be described later with reference to a flowchart of FIG. 10.

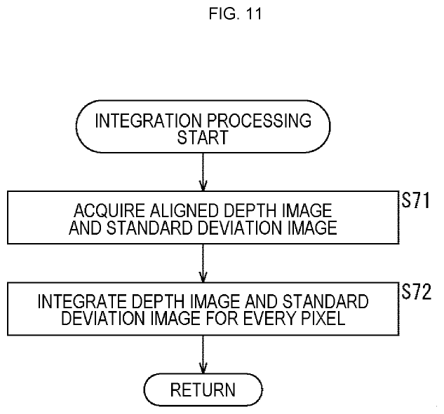

In step S6, the integration unit 13 performs integration processing. In the integration processing, the ToF depth image and the stereo depth image are integrated on the basis of the standard deviation images. Furthermore, two standard deviation images respectively corresponding to the ToF depth image and the stereo depth image are integrated. Details of the integration processing will be described later with reference to a flowchart of FIG. 11.

In step S7, the integration unit 13 outputs the integrated depth image and standard deviation image to a subsequent stage.

After the depth image and the standard deviation image are output, the processing ends.

<Standard Deviation Estimation Processing of ToF Camera>

Here, the standard deviation estimation processing of the ToF camera performed in step S2 of FIG. 7 will be described with reference to the flowchart of FIG. 8.

In step S21, the standard deviation estimation unit 11a acquires the ToF depth image and the confidence image from the ToF camera 1a.

In step S22, the standard deviation estimation unit 11a estimates a standard deviation of the pixel value for every pixel of the ToF depth image on the basis of the confidence image, and generates a standard deviation image.

In step S23, the standard deviation estimation unit 11a outputs the ToF depth image and the standard deviation image to the alignment unit 12a.

After the ToF depth image and the standard deviation image are output, the processing returns to step S2 in FIG. 7, and subsequent processing is performed.

<Standard Deviation Estimation Processing of Stereo Camera>

The standard deviation estimation processing of the stereo camera performed in step S3 of FIG. 7 will be described with reference to the flowchart of FIG. 9.

In step S31, the standard deviation estimation unit 11b acquires the left and right images and the stereo depth image from the stereo camera 1b.

In step S32, the standard deviation estimation unit 11b acquires a focal length and a baseline of the stereo camera 1b. The baseline is information indicating a distance between two cameras constituting the stereo camera.

In step S33, the standard deviation estimation unit 11b performs block matching of all pixels of the left and right images on the basis of depth information recorded in each pixel of the left and right images.

In step S34, the standard deviation estimation unit 11b estimates a standard deviation for every pixel of the stereo depth image on the basis of a result of the block matching, and generates a standard deviation image.

In step S35, the standard deviation estimation unit 11b outputs the stereo depth image and the standard deviation image to the integration unit 13.

After the stereo depth image and the standard deviation image are output, the processing returns to step S3 in FIG. 7, and subsequent processing is performed.

<Alignment Processing>

The alignment processing performed in step S5 of FIG. 7 will be described with reference to the flowchart of FIG. 10.

In step S51, the alignment unit 12a acquires the ToF depth image and the standard deviation image from the standard deviation estimation unit 11a.

In step S52, the alignment unit 12a acquires coordinate transformation information. The coordinate transformation information is information including a rotation matrix R and a translation vector t for transforming a viewpoint of a camera as an alignment source into a viewpoint of a camera as an alignment destination.

In step S53, the alignment unit 12a acquires internal parameters and image sizes of the camera as the alignment source and the camera as the alignment destination. Furthermore, the alignment unit 12a unifies the image size of the ToF depth image and the image size of the stereo depth image.

In step S54, the alignment unit 12a simultaneously aligns the depth image and the standard deviation image for every pixel.

In step S55, the alignment unit 12a outputs the aligned ToF depth image and standard deviation image to the integration unit 13.

After the aligned ToF depth image and standard deviation image are output, the processing returns to step S5 of FIG. 7, and subsequent processing is performed.

<Integration Processing>

The integration processing performed in step S6 of FIG. 7 will be described with reference to the flowchart of FIG. 11.

In step S71, the integration unit 13 acquires the aligned ToF depth image and standard deviation image from the alignment unit 12a, and acquires the stereo depth image and the standard deviation image from the standard deviation estimation unit 11b.

In step S72, the integration unit 13 integrates the stereo depth image and the aligned ToF depth image on the basis of the two standard deviation images. Furthermore, the integration unit 13 integrates the aligned standard deviation image corresponding to the ToF depth image and the standard deviation image corresponding to the stereo depth image.

After the depth images and the standard deviation images are integrated, the processing returns to step S6 of FIG. 7, and subsequent processing is performed.

As described above, in the distance measuring system, the standard deviation image is generated for each of the depth cameras, and the depth images are integrated using the weight based on the standard deviation images. This makes it possible to generate a depth image with high distance accuracy and high resolution. Furthermore, such a high-accuracy and high-resolution depth image can be easily generated without using a large amount of memory or the like.

### 3. MODIFICATIONS

<Example of Performing Alignment to Match Viewpoint of Color Image>

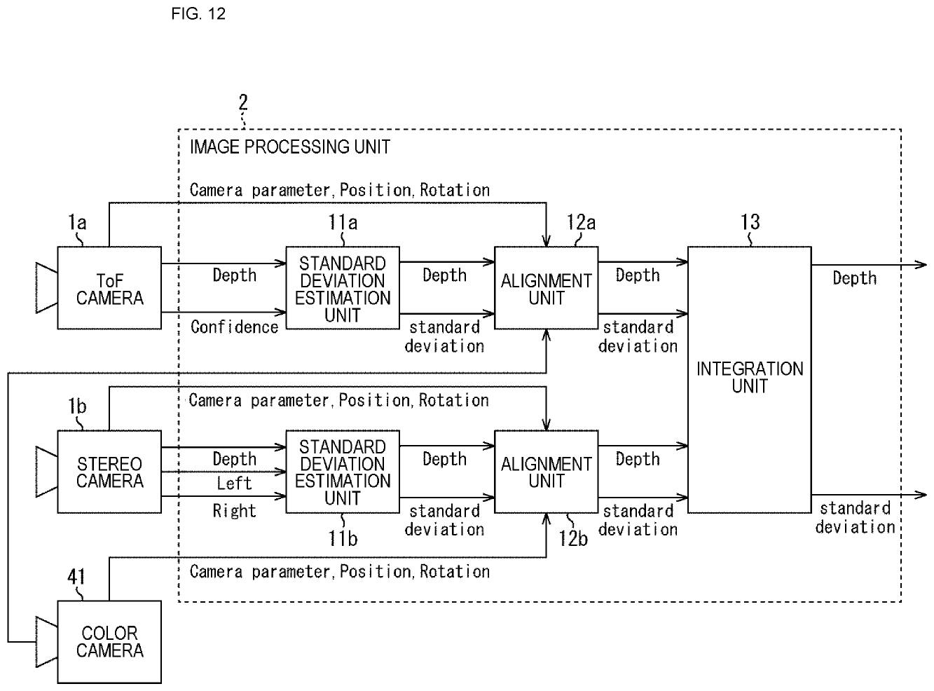

FIG. 12 is a block diagram illustrating another configuration example of the distance measuring system. In FIG. 12, the same configurations as the configurations in FIG. 1 are denoted by the same reference signs. Redundant description will be omitted as appropriate.

The configuration of the distance measuring system illustrated in FIG. 12 is different from the configuration of the distance measuring system in FIG. 1 in that a color camera 41 that generates a color image (RGB image) is provided. Furthermore, the configuration of the image processing unit 2 illustrated in FIG. 12 is different from the configuration of the image processing unit 2 in FIG. 1 in that an alignment unit 12b is provided at a subsequent stage of the standard deviation estimation unit 11b.

The alignment unit 12a performs alignment to match the viewpoints of the ToF depth image and the standard deviation image with a viewpoint of a color image generated by the color camera 41. The alignment is performed on the basis of information on camera parameters, positions, and rotation of the ToF camera 1a and the color camera 41. The information on the camera parameters and the like of the ToF camera 1a and the color camera 41 is supplied to the alignment unit 12a.

The alignment unit 12b performs alignment to match the viewpoints of the stereo depth image and the standard deviation image with the viewpoint of the color image generated by the color camera 41. The alignment is performed on the basis of information on camera parameters, positions, and rotation of the stereo camera 1b and the color camera 41. The information on the camera parameters and the like of the stereo camera 1b and the color camera 41 is supplied to the alignment unit 12b.

The integration unit 13 integrates the aligned ToF depth image and stereo depth image obtained by performing alignment to match the viewpoint of the color image. Therefore, a depth image corresponding to each pixel of the color image is generated. Furthermore, the integration unit 13 integrates two standard deviation images that have been aligned and obtained by performing alignment to match the viewpoint of the color image.

The depth image corresponding to each pixel of the color image and the color image can be used, for example, to generate a colored point group representing colors and positions.

<Example of Performing Alignment to Match Viewpoint of ToF Depth Image>

In the example of FIG. 1, an example in which the alignment is performed to match the viewpoint of the stereo depth image has been described, but the alignment may be performed on the stereo depth image to match the viewpoint of the ToF depth image.

<Configuration Example of Depth Camera>

Depth images generated by a plurality of stereo cameras may be integrated. Furthermore, depth images generated by a plurality of ToF cameras may be integrated. Depth images generated on the basis of a measurement result by a sensor such as light detection and ranging, laser imaging detection and ranging (LIDAR) or radio detection and ranging (RADAR) may be integrated.

As described above, if the standard deviation image can be generated, the distance measuring system can integrate a plurality of depth images generated by the same type of depth camera or different types of depth cameras.

By integrating depth images generated by three or more depth cameras facing different directions, one panoramic depth image may be generated by the integration unit 13.

### OTHERS

In the standard deviation image, an example in which the standard deviation of the depth information recorded in the depth image is recorded as the pixel value has been described. However, other information indicating ambiguity of the depth information may be recorded as the pixel value. Information indicating ambiguity of depth information such as probability density and average deviation is recorded as the pixel value.

### APPLICATION EXAMPLES

The distance measuring system of the present technology can be applied to virtual reality (VR) and augmented reality (AR). For example, the depth image generated by the distance measuring system of the present technology is used for separating the foreground and the background.

In a case where a contour of an object in the foreground cannot be accurately detected on the basis of the depth image, a relationship between the foreground and the background is displayed in a relationship different from an actual relationship, such as an object in the back is displayed in front, and a user may feel uncomfortable. By using the depth image generated by the distance measuring system of the present technology, it is possible to accurately detect the contour of the object and accurately separate the foreground and the background.

Furthermore, the depth image generated by the distance measuring system of the present technology is also used for generating a background blur. The contour of the object can accurately be detected, and the background blur can accurately be generated.

The distance measuring system of the present technology can be applied to distance measurement of an object. The distance measuring system of the present technology can generate a depth image in which a distance to a small object, a thin object, a human body, or the like is accurately measured. Furthermore, in a case where a task of detecting a contour of a person from a color image and measuring a distance to the person is executed, the distance measuring system of the present technology can generate a depth image whose viewpoint matches that of the color image.

The distance measuring system of the present technology can be applied to volumetric capturing. For example, the distance measuring system of the present technology can generate a depth image in which a distance to a fingertip of a person is accurately measured.

The distance measuring system of the present technology can be applied to a robot. For example, a depth image generated by the distance measuring system can be used for robot decision-making. Furthermore, a standard deviation image generated by the distance measuring system can be used for the robot decision-making, such as making a decision while ignoring depth information recorded in a pixel having a large standard deviation.

<About Computer>

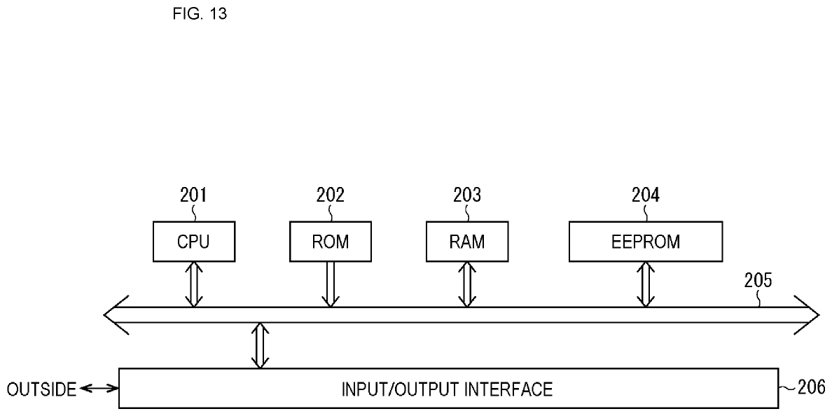

FIG. 13 is a block diagram illustrating a configuration example of hardware of a computer that executes the above-described series of processing by a program.

In the computer, a central processing unit (CPU) 201, a read only memory (ROM) 202, a random access memory (RAM) 203, and an electronically erasable and programmable read only memory (EEPROM) 204 are connected to one another by a bus 205. Moreover, an input/output interface 206 is connected to the bus 205, and the input/output interface 206 is connected to the outside.

In the computer configured as described above, for example, the CPU 201 loads a program stored in the ROM 202 and the EEPROM 204 into the RAM 203 via the bus 205 and executes the program, whereby the above-described series of processing is performed. Furthermore, the program executed by the computer (CPU 201) can be written in advance in the ROM 202, and can be installed or updated in the EEPROM 204 from the outside via the input/output interface 206.

The program executed by the computer may be a program in which processing is performed in time series in the order described in the present specification, or may be a program in which processing is performed in parallel or at necessary timing such as when a call is made or the like.

In the present specification, a system is intended to mean assembly of a plurality of components (devices, modules (parts), and the like) and it does not matter whether or not all the components are in the same casing. Therefore, a plurality of devices accommodated in different casings connected through the network and one device obtained by accommodating a plurality of modules in one casing are the systems.

The effects described in the present specification are merely examples and are not limited, and other effects may be provided.

Embodiments of the present technology are not limited to the abovementioned embodiment, and various modifications are possible without departing from the gist of the present technology.

For example, the present technology can employ a configuration of cloud computing in which one function is shared by a plurality of devices via a network and processed in cooperation with each other.

Furthermore, the steps described in the above-described flowcharts can be executed by a single device or shared and executed by a plurality of devices.

Moreover, in a case where a plurality of processing is included in one step, the plurality of processing included in the one step can be executed by a single device or shared and executed by a plurality of devices.

<Combination Example of Configurations>

The present technology can also have the following configurations.

(1)

An image processing device including:

a generation unit that generates a reference image in which information indicating ambiguity of a pixel value of each pixel of a depth image acquired from a sensor that measures a distance is set as a pixel value of each pixel; and

an integration unit that integrates a plurality of the depth images on the basis of the reference image corresponding to each of the plurality of the depth images.

(2)

The image processing device according to (1), further including

an alignment unit that performs alignment that is processing of matching a viewpoint of the depth image and a viewpoint of the reference image with a reference viewpoint,

in which the integration unit integrates the plurality of the depth images obtained by the alignment.

(3)

The image processing device according to (2), in which

the alignment unit matches viewpoints of the plurality of the depth images with a viewpoint of one of the plurality of the depth images.

(4)

The image processing device according to (2), in which

the alignment unit matches viewpoints of the plurality of the depth images with a viewpoint of a color image.

(5)

The image processing device according to any one of (1) to (4), in which

the integration unit integrates pixels of the plurality of the depth images by using weight corresponding to the information indicating the ambiguity of the pixel value.

(6)

The image processing device according to any one of (1) to (5), in which

the integration unit further integrates a plurality of the reference images.

(7)

The image processing device according to any one of (1) to (6), in which

the information indicating the ambiguity of the pixel value is a standard deviation.

(8)

The image processing device according to any one of (1) to (7), in which

the reference image is an image having the same resolution as resolution of the depth image.

(9)

The image processing device according to any one of (1) to (8), further including:

a plurality of the sensors that measures a distance by different distance measuring methods.

(10)

The image processing device according to (9), in which

the sensor includes a ToF camera, a stereo camera, a LIDAR, and a RADAR.

(11)

The image processing device according to any one of (1) to (10), in which

the generation unit estimates information indicating ambiguity of a pixel value of a depth image generated by a ToF camera as the sensor on the basis of an image indicating light reception intensity at the time of distance measurement generated by the ToF camera.

(12)

The image processing device according to any one of (1) to (11), in which

the generation unit estimates information indicating ambiguity of a pixel value of a depth image generated by a stereo camera as the sensor on the basis of two images having parallax generated by the stereo camera.

(13)

An image processing method including:

generating a reference image in which information indicating ambiguity of a pixel value of each pixel of a depth image acquired from a sensor that measures a distance is set as a pixel value of each pixel; and

integrating a plurality of the depth images on the basis of the reference image corresponding to each of the plurality of the depth images.

(14)

A program for causing a computer to execute processing of:

generating a reference image in which information indicating ambiguity of a pixel value of each pixel of a depth image acquired from a sensor that measures a distance is set as a pixel value of each pixel; and

integrating a plurality of the depth images on the basis of the reference image corresponding to each of the plurality of the depth images.

### REFERENCE SIGNS LIST

1a ToF camera
1b Stereo camera
2 Image processing unit
11a, 11b Standard deviation estimation unit
12a, 12b Alignment unit
13 Integration unit

1. An image processing device comprising:
a generation unit that generates a reference image in which information indicating ambiguity of a pixel value of each pixel of a depth image acquired from a sensor that measures a distance is set as a pixel value of each pixel; and
an integration unit that integrates a plurality of the depth images on a basis of the reference image corresponding to each of the plurality of the depth images.

2. The image processing device according to claim 1, further comprising
an alignment unit that performs alignment that is processing of matching a viewpoint of the depth image and a viewpoint of the reference image with a reference viewpoint,
wherein the integration unit integrates the plurality of the depth images obtained by the alignment.

3. The image processing device according to claim 2, wherein
the alignment unit matches viewpoints of the plurality of the depth images with a viewpoint of one of the plurality of the depth images.

4. The image processing device according to claim 2, wherein
the alignment unit matches viewpoints of the plurality of the depth images with a viewpoint of a color image.

5. The image processing device according to claim 1, wherein
the integration unit integrates pixels of the plurality of the depth images by using weight corresponding to the information indicating the ambiguity of the pixel value.

6. The image processing device according to claim 1, wherein
the integration unit further integrates a plurality of the reference images.

7. The image processing device according to claim 1, wherein
the information indicating the ambiguity of the pixel value is a standard deviation.

8. The image processing device according to claim 1, wherein
the reference image is an image having same resolution as resolution of the depth image.

9. The image processing device according to claim 1, further comprising:
a plurality of the sensors that measures a distance by different distance measuring methods.

10. The image processing device according to claim 9, wherein
the sensor includes a ToF camera, a stereo camera, a LIDAR, and a RADAR.

11. The image processing device according to claim 1, wherein
the generation unit estimates information indicating ambiguity of a pixel value of a depth image generated by a ToF camera as the sensor on a basis of an image indicating light reception intensity at a time of distance measurement generated by the ToF camera.

12. The image processing device according to claim 1, wherein
the generation unit estimates information indicating ambiguity of a pixel value of a depth image generated by a stereo camera as the sensor on a basis of two images having parallax generated by the stereo camera.

13. An image processing method comprising:
generating a reference image in which information indicating ambiguity of a pixel value of each pixel of a depth image acquired from a sensor that measures a distance is set as a pixel value of each pixel; and
integrating a plurality of the depth images on a basis of the reference image corresponding to each of the plurality of the depth images.

14. A program for causing a computer to execute processing of:
generating a reference image in which information indicating ambiguity of a pixel value of each pixel of a depth image acquired from a sensor that measures a distance is set as a pixel value of each pixel; and
integrating a plurality of the depth images on a basis of the reference image corresponding to each of the plurality of the depth images.
